(19) United States
(12) Patent Application Publication
(10) Pub. No.: US 2015/0151219 A1
(43) Pub. Date: Jun. 4, 2015

(54) Multiphase Separation System

(71) Applicants: Edward J Grave, Spring, TX (US); Adam S. Bymaster, Burleson, TX (US); Tracy A. Fowler, Sugar Land, TX (US)

(72) Inventors: Edward J Grave, Spring, TX (US); Adam S. Bymaster, Burleson, TX (US); Tracy A. Fowler, Sugar Land, TX (US)

(21) Appl. No.: 14/406,119

(22) PCT Filed: May 1, 2013
(86) PCT No.: PCT/US13/39089

§ 371 Date: Dec. 5, 2014

Related U.S. Application Data
(60) Provisional application No. 61/676,753, filed on Jul. 27, 2012.

(51) Int. Cl. B01D 19/00

(52) U.S. Cl. CPC B01D 19/0042

(57) ABSTRACT

A system and method for separation of liquids and gases within a multiphase fluid are provided herein. The method includes flowing a multiphase fluid into a circular distribution header of a multiphase separation system and separating the multiphase fluid into gases and liquids within the circular distribution header. The method also includes flowing the gases into a circular gas header that is above a plane of the circular distribution header and flowing the liquids into a circular liquid header that is below the plane of the circular distribution header. The method further includes flowing the gases out of the multiphase separation system via a gas outlet line and flowing the liquids out of the multiphase separation system via a liquid outlet line, wherein entrained liquids within the gas outlet line are flowed to the liquid outlet line via a downcomer.

### CROSS-REFERENCE TO RELATED APPLICATION

This application claims the benefit of U.S. Provisional Patent Application 61/676,753 filed Jul. 27, 2012 entitled MULTIPHASE SEPARATION SYSTEM, the entirety of which is incorporated by reference herein.

### FIELD OF THE INVENTION

The present techniques provide for the separation of gases and liquids within production fluids. More specifically, the techniques provide for the separation of production fluids into gases and liquids using a subsea multiphase separation system.

### BACKGROUND

This section is intended to introduce various aspects of the art, which may be associated with exemplary embodiments of the present techniques. This discussion is believed to assist in providing a framework to facilitate a better understanding of particular aspects of the present techniques. Accordingly, it should be understood that this section should be read in this light, and not necessarily as admissions of prior art.

Any of a number of subsea separation techniques may be used to enhance the amount of oil and gas recovered from subsea wells. However, subsea separation at water depths greater 1500 meters becomes especially challenging due to the environmental conditions. As water depth increases, the external pressure on a vessel created by the hydrostatic head increases the required wall thickness for vessels used for subsea processing. At water depths greater than 1500 meters, this wall thickness has increased to such an extent that typical gravity separation is not practical. In addition, vessels with such a large wall thickness can be a challenge to fabricate, and the added material and weight can impact project economics, as well as the availability of the vessel for maintenance. As a result, large diameter separators often cannot be used at such depths.

### SUMMARY

An exemplary embodiment provides a multiphase separation system including an inlet line configured to feed a multiphase fluid into a circular distribution header within the multiphase separation system, wherein the circular distribution header is coupled to a number of upper lines and a number of lower lines. Each upper line is configured to feed gases into a circular gas header, wherein the circular gas header is in a second plane that is above a plane of the circular distribution header. Each lower line is configured to feed liquids into a circular liquid header, wherein the circular liquid header is in a third plane that is below the plane of the circular distribution header. The multiphase separation system also includes a gas outlet line that is coupled to the circular gas header and is configured to flow the gases out of the multiphase separation system, and a liquid outlet line that is coupled to the circular liquid header and is configured to flow the liquids out of the multiphase separation system. The gas outlet line and the liquid outlet line are coupled via a downcomer configured to allow entrained liquids to flow from the gas outlet line to the liquid outlet line.

Another exemplary embodiment provides a method for separation of liquids and gases within a multiphase fluid. The method includes flowing a multiphase fluid into a circular distribution header of a multiphase separation system and separating the multiphase fluid into gases and liquids within the circular distribution header. The method also includes flowing the gases into a circular gas header that is above a plane of the circular distribution header and flowing the liquids into a circular liquid header that is below the plane of the circular distribution header. The method further includes flowing the gases out of the multiphase separation system via a gas outlet line and flowing the liquids out of the multiphase separation system via a liquid outlet line, wherein entrained liquids within the gas outlet line are flowed to the liquid outlet line via a downcomer.

### BRIEF DESCRIPTION OF THE DRAWINGS

The advantages of the present techniques are better understood by referring to the following detailed description and the attached drawings, in which:

FIG. 1 is a block diagram showing a system for separating production fluids into a gas stream and a liquid stream using a multiphase separation system;

FIG. 2 is a perspective view of a multiphase separation system;

FIG. 3 is a side view of the multiphase separation system of FIG. 2;

FIG. 4 is a process flow diagram showing a method for separating gases and liquids within a multiphase fluid;

FIG. 5 is a perspective view of another multiphase separation system;

FIG. 6 is a side view of the multiphase separation system of FIG. 5;

FIG. 7 is a perspective view of another multiphase separation system; and

FIG. 8 is a side view of the multiphase separation system of FIG. 7.

### DETAILED DESCRIPTION

In the following detailed description section, specific embodiments of the present techniques are described. However, to the extent that the following description is specific to a particular embodiment or a particular use of the present techniques, this is intended to be for exemplary purposes only and simply provides a description of the exemplary embodiments. Accordingly, the techniques are not limited to the specific embodiments described below, but rather, include all alternatives, modifications, and equivalents falling within the true spirit and scope of the appended claims.

As discussed above, traditional large diameter separators face technical challenges at depths greater than approximately 1500 meters. Thus, embodiments described herein provide an unconventional separation system that is capable of achieving acceptable gas-liquid separation and damping potential flow fluctuations, while meeting the size and weight restrictions imposed on deepwater processing units. Further, the separation system can be designed to pipe code instead of vessel code, which may provide cost and weight savings. In many cases, for a given pressure class, the required wall thickness for a pipe is less than the required wall thickness for a corresponding vessel.

According to embodiments described herein, a compact, subsea multiphase separation system is used to enhance subsea well production, especially in deepwater and Arctic environments. In various embodiments, the subsea multiphase separation system is a four phase subsea separator that is configured to separate production fluids into a gas phase, an oil phase, an aqueous phase, and a solid phase. In other words, subsea separation may be used to create single phase streams. This may allow for the usage of single phase pumps, which are more efficient and can achieve larger pressure differentials compared to multiphase pumps. In order to pump a single phase stream, one single phase pump may be sufficient. In contrast, in order to pump a multiphase stream, a series of multiphase pumps may be used to achieve the same pressure differential, especially for high boosting applications.

The separation process described herein may be used to achieve bulk removal of aqueous fluids from production fluids. The removal of aqueous fluids is termed water removal herein, although this may be understood to include water with other contaminants, such as salts or other miscible fluids. Such bulk water removal may mitigate flow assurance concerns, by allowing substantially pure oil and/or gas streams to be sent to the surface. These substantially pure streams will form lower amounts of hydrates, such as methane clathrates, thus lowering the risk of plugging or flow restrictions. Further, corrosion concerns can be reduced or eliminated. The sand and water by-product streams can then be disposed topsides to dedicated disposal zones, reservoirs, the seabed, or the like.

Bulk water removal may also result in a decrease in the hydrostatic head acting on the reservoir, thus increasing both the reservoir drive and production. Further, the separation process may be used to reduce flow line infrastructure, reduce the number of topside water treating facilities, reduce power and pumping requirements, and de-bottleneck existing facilities that are challenged with declining production rates due to increased water cuts.

As used herein, the term “slug” refers to a small volume of fluid that is entrained within the production fluids and is often of a higher density than the production fluids, for example, a liquid zone carried along by gas flow in a pipeline. Slugs may affect the flow characteristics of the production fluids. In addition, slugs exiting a pipeline may overload the gas-liquid handling capacity of the subsea, topsides, or onshore processing facility at the pipeline outlet. Thus, according to embodiments described herein, one or more subsea multiphase slug catchers may be used to dampen or remove the slugs from the production fluids before the production fluids enter the export pipelines.

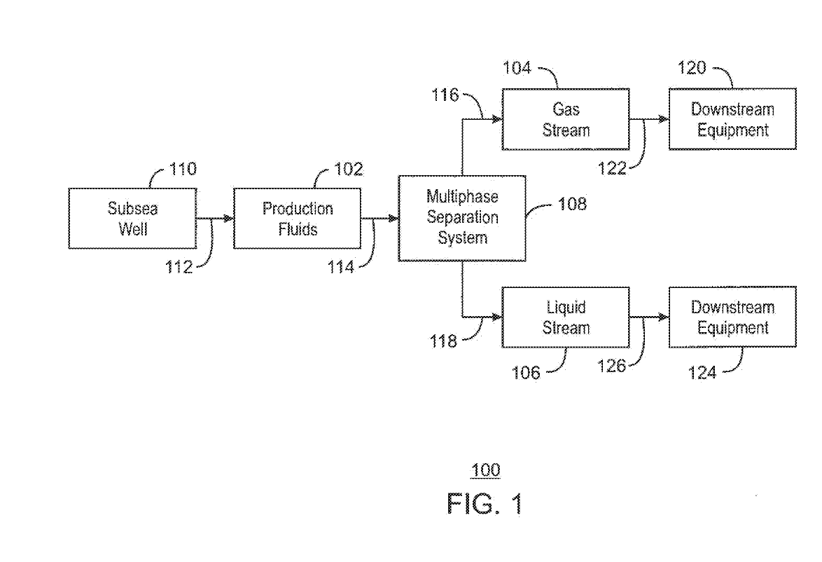

FIG. 1 is a block diagram showing a system 100 for separating production fluids 102 into a gas stream 104 and a liquid stream 106 using a multiphase separation system 108. The production fluids 102 may be hydrocarbon fluids that include a mixture of natural gas, oil, brine, and solid impurities, such as sand. The production fluids 102 may be obtained from a subsea well 110, as indicated by arrow 112. The production fluids 102 may be obtained from the subsea well 110 via any type of subsea production system (not shown) that is configured to produce hydrocarbons from subsea locations.

In an embodiment, the production fluids 102 are flowed into the multiphase separation system 108, as indicated by arrow 114. The multiphase separation system 108 may be any type of vessel that is configured to achieve bulk separation of gas and liquid from the production fluids 102. In addition, the multiphase separation system 108 may remove slugs from the production fluids 102. The multiphase separation system 108 may be implemented within a subsea environment.

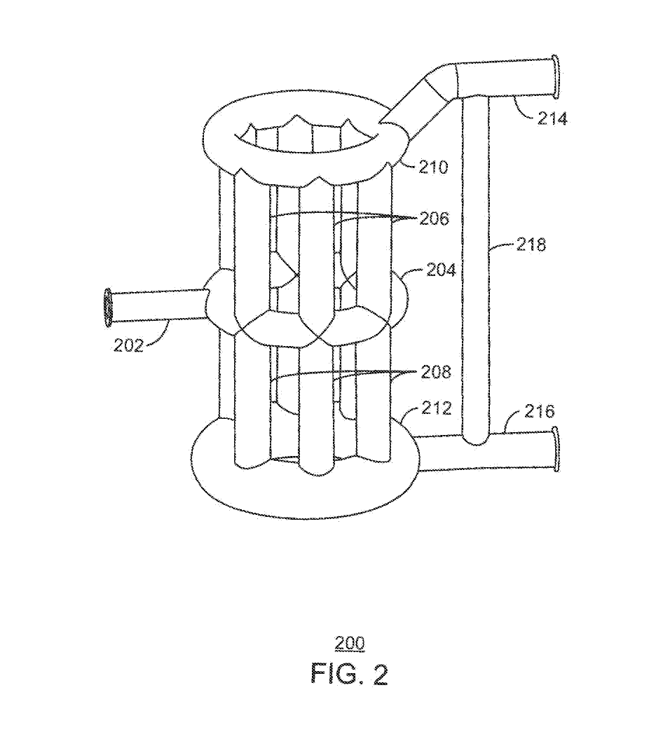

Within the multiphase separation system 108, the production fluids 108 may be separated into the gas stream 104 and the liquid stream 106, as indicated by arrows 116 and 118, respectively. The gas stream 104 may include natural gas, while the liquid stream 106 may include water, oil, and other residual impurities, such as sand. Designs for the multiphase separation system 108, as well as the mechanisms by which the multiphase separation system 108 may affect the quality of the separated gas stream 104 and the separated liquid stream 106, are described with respect to FIGS. 2-8.

In some embodiments, the gas stream 104 is flowed to downstream equipment 120, as indicated by arrow 122. The downstream equipment 120 may include, for example, any type of downstream gas processing equipment, such as a gas compressor, gas treatment facility, gas polishing device, or the like, or a gas pipeline. In addition, the liquid stream 106 may be flowed to downstream equipment 124, as indicated by arrow 126. The downstream equipment 124 may include, for example, oil and water pre-treating or coalescence equipment, such as a heating system, chemical injection system, electrostatic coalescer, or the like, a pipe separator or cyclone for oil-water separation, or a liquid export pipeline.

The block diagram of FIG. 1 is not intended to indicate that the system 100 is to include all of the components shown in FIG. 1. Further, any number of additional components may be included within the system 100, depending on the details of the specific implementation. For example, the multiphase separation system 108 can be designed to achieve liquid/liquid separation, thus delivering two substantially pure oil and water streams to the downstream equipment 124. Further, multiphase and single phase desanders may be placed upstream and/or downstream of the multiphase separation system 108.

FIG. 2 is a perspective view of a multiphase separation system 200. The multiphase separation system 200 may include an inlet line 202 configured to feed the multiphase fluid into a circular distribution header 204. The multiphase fluid may be any type of fluid that includes both liquid and gaseous components. For example, the multiphase fluid may be production fluids from a subsea well. The circular distribution header 204 may be coupled to a number of upper lines 206 and a number of lower lines 208. The upper lines 206 and the lower lines 208 may be perpendicular to the circular distribution header 204.

Each upper line 206 may feed gases within the multiphase fluid into a circular gas header 210. The circular gas header 210 may be in a second plane that is above and substantially parallel to the circular distribution header 204. In addition, each lower line 208 may feed liquids within the multiphase fluid into a circular liquid header 212. The circular liquid header 212 may be below and substantially parallel to the circular distribution header 204.

A gas outlet line 214 may be coupled to the circular gas header 210 and may be configured to flow the gases out of the multiphase separation system 200. A liquid outlet line 216 may be coupled to the circular liquid header 212 and may be configured to flow the liquids out of the multiphase separation system 200. The gas outlet line 214 and the liquid outlet line 216 may be coupled via a downcomer 218. The downcomer 218 may be configured at a right angle or an oblique angle.

The downcomer 218 may allow entrained liquids within the gases to flow from the gas outlet line 214 to the liquid outlet line 216. In addition, the downcomer 218 may allow entrained gases within the liquids to flow from the liquid outlet line 216 to the gas outlet line 214. However, in some embodiments, the separation of gases and liquids may be sufficient in the upper lines 206 and the lower lines 208 perpendicular to the circular distribution header 204. In this case, the downcomer 218 may be omitted from the multiphase separation system 200.

The schematic of FIG. 2 is not intended to indicate that the subsea multiphase separation system 200 is to include all of the components shown in FIG. 2. Further, any number of additional components may be included within the subsea multiphase separation system 200, depending on the details of the specific implementation. For example, the liquid outlet line 216 may be extended, with or without an optional sealing downcomer, to increase residence time in the liquid phase and achieve oil/water separation. This may allow for the enhancement or the elimination of downstream oil/water separation steps and equipment. In addition, the liquid outlet line 216 may include separate outlet lines for flowing the oil and water out of the multiphase separation system 200.

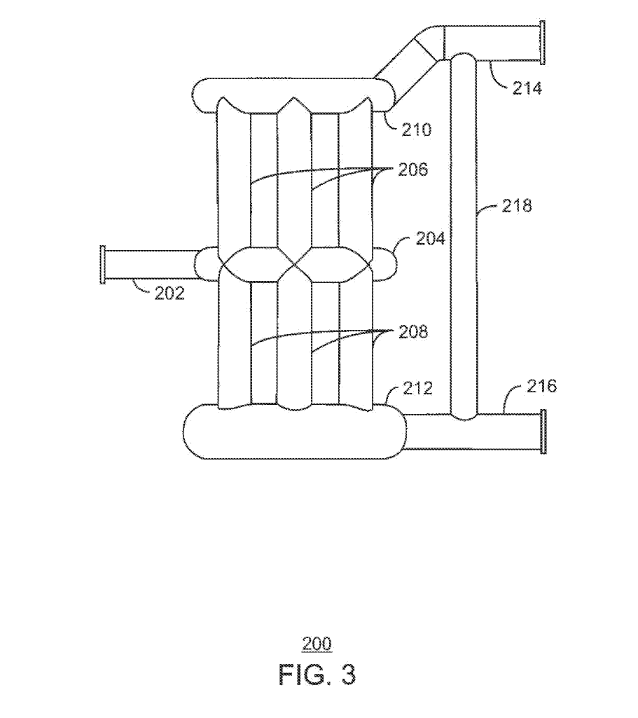

FIG. 3 is a side view of the multiphase separation system 200 of FIG. 2. As shown in FIG. 3, the circular distribution header 204 may be in the same plane as the inlet line 202. Thus, the multiphase fluid may flow directly into the circular distribution header 204. Due to the configuration of the circular distribution header 204, the multiphase fluid flow may initially distribute along two flow paths within the circular distribution header 204, resulting in a reduction in velocity of the multiphase fluid as it flows throughout the circular distribution header 204. In some embodiments, such a reduction in velocity of the multiphase fluid dissipates any slugs within the multiphase fluid. In addition, the circular distribution header 204 may act as a stratification section that is configured to perform an initial bulk separation of gases and liquids within the multiphase fluid.

The upper lines 206 may be perpendicular to the circular distribution header 204 and may couple the circular distribution header 204 to the circular gas header 210. The lower lines 208 may be perpendicular to the circular distribution header 204 and may couple the circular distribution header 204 to the circular liquid header 212. The circular gas header 210 and the circular liquid header 212 may be parallel to the circular distribution header 204.

In some embodiments, the circular gas header 210 acts as a droplet separation section configured to remove entrained liquids from the gases within the circular gas header 210. In addition, in some embodiments, the circular liquid header 212 acts as a liquid degassing section configured to remove entrained gases from the liquids within the circular liquid header 212.

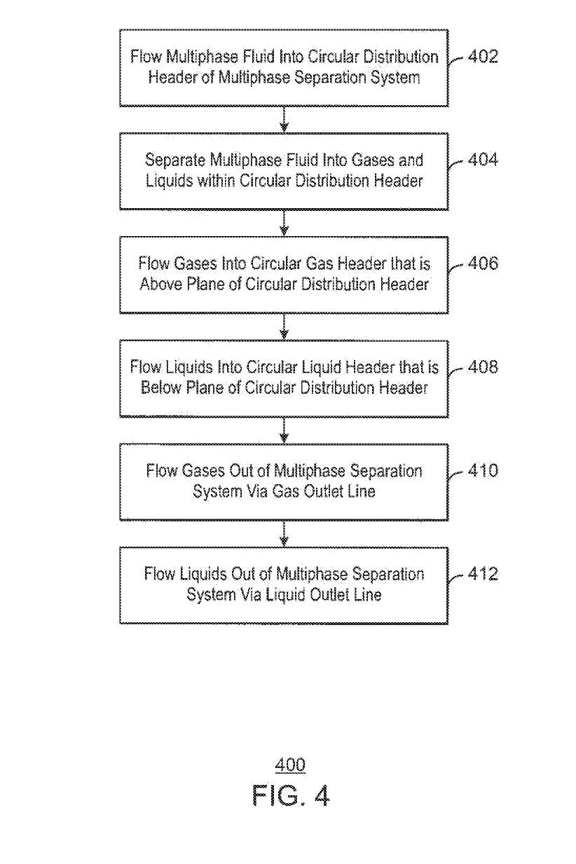

FIG. 4 is a process flow diagram showing a method 400 for separating gases and liquids within a multiphase fluid. In various embodiments, the multiphase separation system 200 discussed above with respect to FIGS. 2 and 3 is used to implement the method 400.

The method begins at block 402, at which the multiphase fluid is flowed into a circular distribution header of the multiphase separation system. The multiphase fluid may be flowed into the circular distribution header via an inlet line of the multiphase separation system.

At block 404, the multiphase fluid is separated into gases and liquids within the circular distribution header. The circular distribution header may be a stratification section that allows for an initial bulk separation of the gases and liquids. However, some amount of liquids may be entrained within the gases, and some amount of gases may be entrained within the liquids. In addition, the circular distribution header may dissipate any slugs that are within the multiphase fluid.

At block 406, the gases are flowed into a circular gas header that is above a plane of the circular distribution header. The gases may be flowed into the circular gas header via a number of upper lines that are perpendicular the circular distribution header. In various embodiments, the velocity and pressure of the gases are lowered by splitting the gases among the upper lines.

At block 408, the liquids are flowed into a circular liquid header that is below the plane of the circular distribution header. The liquids may be flowed into the circular liquid header via a number of lower lines that are perpendicular to the circular distribution header. In various embodiments, the velocity and pressure of the liquids are lowered by splitting the liquids among the lower lines.

At block 410, the gases are flowed out of the multiphase separation system via a gas outlet line. The gases may be sent to a gas export line or any other type of downstream equipment. At block 412, the liquids are flowed out of the multiphase separation system via a liquid outlet line. The liquids may be sent to a liquid export line or any other type of downstream equipment.

As the gases and the liquids are flowing out of the multiphase separation system, entrained liquids within the gas outlet line are flowed to the liquid outlet line via a downcomer. In addition, entrained gases within the liquid outlet line are allowed to rise to the gas outlet line via the downcomer.

The process flow diagram of FIG. 4 is not intended to indicate that the steps of the method 400 are to be executed in any particular order, or that all of the steps of the method 400 are to be included in every cases. Further, any number of additional steps not shown in FIG. 4 may be included within the method 400, depending on the details of the specific implementation.

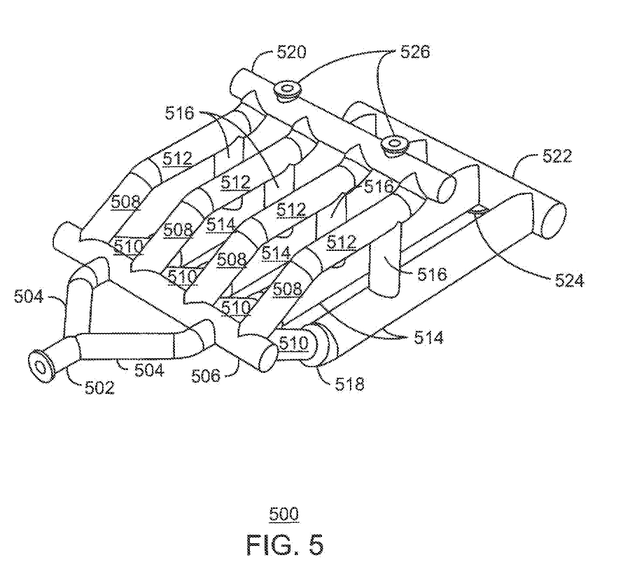

FIG. 5 is a perspective view of another multiphase separation system 500. The multiphase separation system 500 may include an inlet line 502 that is configured to allow a multiphase fluid to flow into the multiphase separation system 500. The inlet line 502 may include a number of divisions 504 that are configured to lower the velocity of the multiphase fluid and feed the multiphase fluid into a distribution header 506.

The distribution header 506 may be configured to split the multiphase fluid among a number of upper fingers 508 and a number of lower fingers 510. Each upper finger 508 is angled upward to feed into a corresponding upper pipe 512 in a first plane disposed above and substantially parallel to the distribution header 506. Each lower finger 510 is angled downward to feed into a corresponding lower pipe 514 in a second plane disposed below and substantially parallel to the distribution header 506. In addition, each upper pipe 512 may be coupled to a corresponding lower pipe 514 via a downcomer 516. The downcomer 516 may be configured perpendicular to the upper pipes 512 and lower pipes 514, or may be at an oblique angle.

Each lower pipe 514 may include an expansion zone 518 that is configured to lower a velocity and a pressure of liquids within the lower pipe 514. This may allow entrained gases within the liquids to rise to the corresponding upper pipe 512 via the downcomer 516.

Each upper pipe 512 may feed into a common gas header 520. The gas header 520 may be configured to lower a velocity of gases within the upper pipe 512 to allow entrained liquids, such as droplets, within the gases to coalesce and drop to the corresponding lower pipe 514 via the downcomer 516.

The multiphase separation system 500 may also include a liquid header 522 for collecting the liquids and flowing the liquids out of the multiphase separation system 500 via liquid outlet lines 524. In addition, the gas header 520 may include gas outlet lines 526 for flowing the gases out of the multiphase separation system 500.

The schematic of FIG. 5 is not intended to indicate that the subsea multiphase separation system 500 is to include all of the components shown in FIG. 5. Further, any number of additional components may be included within the subsea multiphase separation system 500, depending on the details of the specific implementation. For example, the lower pipe 514 may be extended, with or without an optional sealing downcomer, to increase residence time in the liquid phase and achieve oil/water separation. This may allow for the enhancement or the elimination of downstream oil/water separation steps and equipment. Separate oil and water outlets can be included in the liquid header 522 for flowing the oil and water out of the multiphase separation system 500.

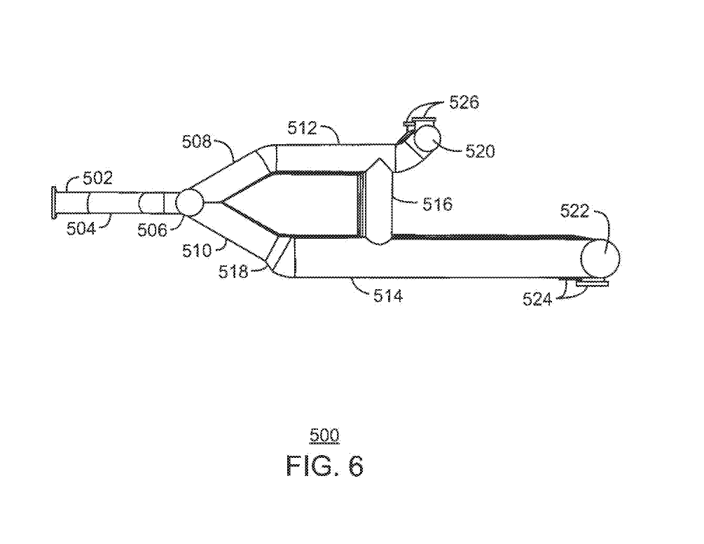

FIG. 6 is a side view of the multiphase separation system 500 of FIG. 5. As shown in FIG. 6, the divisions 504 may be in the same plane as the inlet line 502. Thus, the multiphase fluid may be flowed directly into the divisions 504 from the inlet line 502. However, because the multiphase fluid is split among the divisions 504, the velocity of the multiphase fluid is reduced. In some embodiments, the reduction in velocity of the multiphase fluid dissipates any slugs within the multiphase fluid.

The distribution header 506 may also be in the same plane as the inlet line 502. Thus, the multiphase fluid may be flowed directly into the distribution header 506 from the divisions 504. Within the distribution header 506, the multiphase fluid may be split among the upper fingers 508 and the lower fingers 510. This may further reduce the velocity of the multiphase fluid.

In some embodiments, the distribution header 506 is a stratification section that is configured to perform an initial bulk separation of gases and liquids within the multiphase fluid. Thus, gases may be flowed into the upper fingers 508, and liquids may be flowed into the lower fingers 510. The gases may be flowed from the upper fingers 508 to corresponding upper pipes 512, and the liquids may be flowed from the lower fingers 510 to corresponding lower pipes 514. In some embodiments, the upper pipes 512 are parallel to the lower pipes 514.

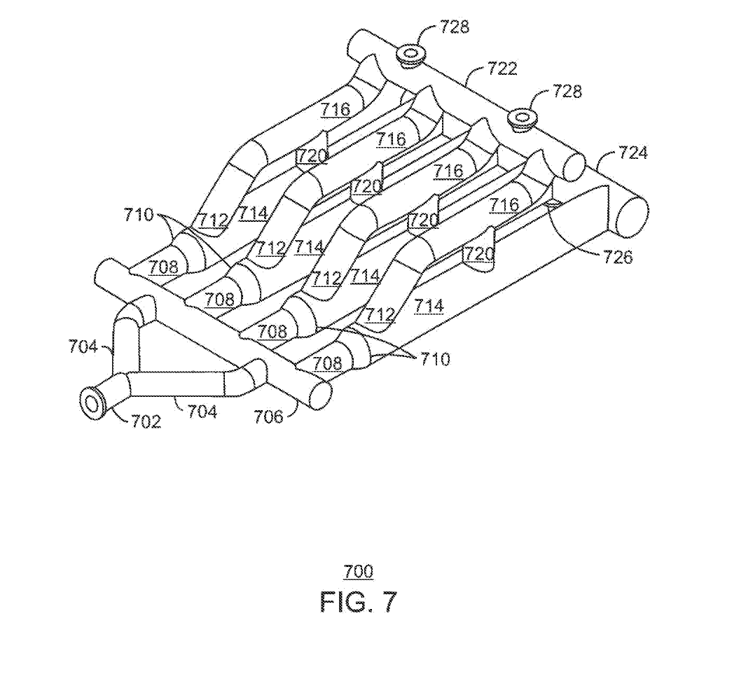

FIG. 7 is a perspective view of another multiphase separation system 700. The multiphase separation system 700 may include an inlet line 702 configured to allow a multiphase fluid to flow into the multiphase separation system 700. The inlet line 702 may include a number of divisions 704 configured to lower a velocity of the multiphase fluid and feed the multiphase fluid into a distribution header 706.

The distribution header 706 is configured to split the multiphase fluid among a number of pipes 708 in a same plane as the distribution header. Each pipe 708 may include an expansion zone 710 configured to lower the velocity and the pressure of the multiphase fluid. The multiphase fluid is split between each upper finger 712 and a corresponding lower pipe 714.

Each upper finger 712 may feed into a corresponding upper pipe 716 in a second plane disposed above and substantially parallel to the plane of the distribution header 706. Each lower pipe 714 may be in the same plane as the distribution header 706. In addition, each upper pipe 716 may be coupled to a corresponding lower pipe 714 via a downcomer 720. The downcomer 720 may be configured at a right angle (as shown) or an oblique angle.

Each lower pipe 714 can be configured to allow entrained gases within liquids to rise to the corresponding upper pipe 716 via the downcomer 720. Each upper pipe 716 may feed into a common gas header 722. The gas header 722 may be configured to lower a velocity of gases to allow entrained liquid droplets to coalesce and drop to any of the lower pipes 714 via any of the downcomers 720.

The multiphase separation system 700 may include a liquid header 724 for collecting the liquids from the lower pipes 714 and flowing the liquids out of the multiphase separation system 700 via liquid outlet lines 726. In addition, the gas header 722 may include gas outlet lines 728 for flowing the gases out of the multiphase separation system 700.

The schematic of FIG. 7 is not intended to indicate that the subsea multiphase separation system 700 is to include all of the components shown in FIG. 7. Further, any number of additional components may be included within the subsea multiphase separation system 700, depending on the details of the specific implementation. For example, the lower pipe 714 may be extended, with or without an optional sealing downcomer, to increase residence time in the liquid phase and achieve oil/water separation. This may allow for the enhancement or the elimination of downstream oil/water separation steps and equipment. Separate oil and water outlets can be included in the liquid header 724 for flowing the oil and water out of the multiphase separation system 700.

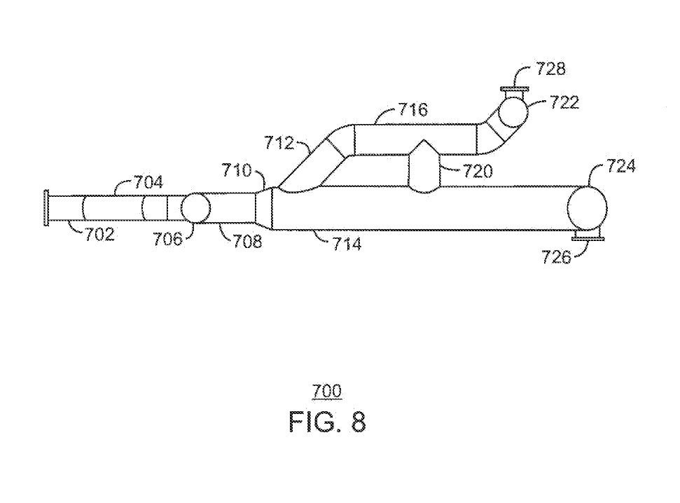

FIG. 8 is a side view of the multiphase separation system 700 of FIG. 7. As shown in FIG. 8, the divisions 704 may be in the same plane as the inlet line 702. Thus, the multiphase fluid may be flowed directly into the divisions 704 from the inlet line 702. However, because the multiphase fluid is split among the divisions 704, the velocity of the multiphase fluid is reduced. In some embodiments, such a reduction in velocity of the multiphase fluid dissipates any slugs within the multiphase fluid.

The distribution header 706 may also be in the same plane as the inlet line 702. Thus, the multiphase fluid may be flowed directly into the distribution header 706 from the divisions 704. Within the distribution header 706, the multiphase fluid may be split among the pipes 708. Within the pipes 708, the multiphase fluid may be flowed through the expansion zone 710, resulting in a reduction of the pressure and velocity of the multiphase fluid.

The multiphase fluid may then be split between each of the upper fingers 712 and the corresponding lower pipe 714. This may further reduce the velocity of the multiphase fluid. In some embodiments, the distribution header 706 acts as a stratification section that is configured to perform an initial bulk separation of gases and liquids within the multiphase fluid. Thus, gases may be flowed into the upper fingers 712, and liquids may remain in the lower pipes 714. In addition, the gases may be flowed from the upper fingers 712 to corresponding upper pipes 716. In some embodiments, the upper pipes 716 are parallel to the lower pipes 714.

### EMBODIMENTS

Embodiments of the invention may include any combinations of the methods and systems shown in the following numbered paragraphs. This is not to be considered a complete listing of all possible embodiments, as any number of variations can be envisioned from the description above.

1. A multiphase separation system, including:
an inlet line configured to feed a multiphase fluid into a circular distribution header within the multiphase separation system, wherein the circular distribution header is coupled to a number of upper lines and a number of lower lines;
each upper line configured to feed gases into a circular gas header, wherein the circular gas header is in a second plane that is above a plane of the circular distribution header;
each lower line configured to feed liquids into a circular liquid header, wherein the circular liquid header is in a third plane that is below the plane of the circular distribution header;
a gas outlet line that is coupled to the circular gas header and is configured to flow the gases out of the multiphase separation system; and
a liquid outlet line that is coupled to the circular liquid header and is configured to flow the liquids out of the multiphase separation system;
wherein the gas outlet line and the liquid outlet line are coupled via a downcomer configured to allow entrained liquids to flow from the gas outlet line to the liquid outlet line.
   2. The multiphase separation system of paragraph 1, wherein the number of upper lines and the number of lower lines are perpendicular to the circular distribution header.
   3. The multiphase separation system of any of paragraphs 1 or 2, wherein the circular gas header includes a droplet separation section configured to remove entrained liquids from the gases.
   4. The multiphase separation system of any of paragraphs 1-3, wherein the circular liquid header includes a liquid degassing section configured to remove entrained gases from the liquids.
   5. The multiphase separation system of any of paragraphs 1-4, wherein the multiphase separation system is implemented within a subsea environment.
   6. The multiphase separation system of any of paragraphs 1-5, wherein the circular distribution header includes a stratification section configured to separate gases from liquids within the multiphase fluid.
   7. The multiphase separation system of any of paragraphs 1-6, wherein the multiphase separation system includes a slug catcher.
   8. The multiphase separation system of any of paragraphs 1-7, wherein the second plane and the third plane are parallel to the plane of the distribution header.
   9. The multiphase separation system of any of paragraphs 1-8, wherein the downcomer is configured to allow entrained gases to flow from the liquid outlet line to the gas outlet line.
   10. The multiphase separation system of any of paragraphs 1-9, wherein the multiphase fluid includes production fluids from a subsea well.
   11. The multiphase separation system of any of paragraphs 1-10, wherein a desander is located upstream of the inlet line.
   12. The multiphase separation system of any of paragraphs 1-11, wherein a desander is located downstream of the liquid outlet line.
   13. The multiphase separation system of any of paragraphs 1-12, including;
an oil/water separation section that is coupled to the circular liquid header and is configured to separate the liquids into oil and water;
an oil outlet line that is coupled to the oil/water separation section and is configured to flow the oil out of the multiphase separation system; and
a water outlet line that is coupled to the oil/water separation section and is configured to flow the water out of the multiphase separation system.
   14. The multiphase separation system of paragraph 13, wherein the oil/water separation section is coupled to the circular distribution header via a sealing downcomer.
   15. The multiphase separation system of any of paragraphs 1-13, wherein the gas outlet line and the liquid outlet line are not coupled via the downcomer.
   16. A method for separation of liquids and gases within a multiphase fluid, including:
flowing a multiphase fluid into a circular distribution header of a multiphase separation system;
separating the multiphase fluid into gases and liquids within the circular distribution header;
flowing the gases into a circular gas header that is above a plane of the circular distribution header;
flowing the liquids into a circular liquid header that is below the plane of the circular distribution header;
flowing the gases out of the multiphase separation system via a gas outlet line; and
flowing the liquids out of the multiphase separation system via a liquid outlet line;
wherein entrained liquids within the gas outlet line are flowed to the liquid outlet line via a downcomer.
   17. The method of any of paragraph 16, including flowing the gases into the circular gas header via a number of upper lines that are perpendicular the circular distribution header.
   18. The method of paragraph 17, including lowering a velocity and a pressure of the gases by splitting the gases among the number of upper lines.
   19. The method of any of paragraphs 16 or 17, including flowing the liquids into the circular liquid header via a number of lower lines that are perpendicular the circular distribution header.
   20. The method of paragraph 19, including lowering a velocity and a pressure of the liquids by splitting the liquids among the number of lower lines.
   21. The method of any of paragraphs 16, 17, or 19, including flowing entrained gases within the liquid outlet line to the gas outlet line via the downcomer.
   22. The method of any of paragraphs 16, 17, 19, or 21, wherein the multiphase separation system is implemented within a subsea environment.
   23. The method of any of paragraphs 16, 17, 19, 21, or 22, wherein the multiphase separation system is a slug catcher.
   24. The method of any of paragraphs 16, 17, 19, or 21-23, including separating the multiphase fluid into the gases and the liquids within a stratification section of the circular distribution header.
   25. The method of any of paragraphs 16, 17, 19, or 21-24, including:
flowing the gases from the multiphase separation system to downstream liquid processing equipment or a gas export line; and
flowing the liquids from the multiphase separation system to downstream gas processing equipment or a liquid export line.
   26. The method of any of paragraphs 16, 17, 19, or 21-25, wherein the liquids include residual solid particulates.
   27. The method of any of paragraphs 16, 17, 19, or 21-26, including:
separating the liquids into oil and water;
flowing the oil out of the multiphase separation system via an oil outlet line; and
flowing the water out of the multiphase separation system via a water outlet line.

While the present techniques may be susceptible to various modifications and alternative forms, the embodiments discussed above have been shown only by way of example. However, it should again be understood that the techniques is not intended to be limited to the particular embodiments disclosed herein. Indeed, the present techniques include all alternatives, modifications, and equivalents falling within the true spirit and scope of the appended claims.

What is claimed is:

1. A multiphase separation system, comprising:
an inlet line configured to feed a multiphase fluid into a circular distribution header within the multiphase separation system, wherein the circular distribution header is coupled to a plurality of upper lines and a plurality of lower lines;
each upper line configured to feed gases into a circular gas header, wherein the circular gas header is in a second plane that is above a plane of the circular distribution header;
each lower line configured to feed liquids into a circular liquid header, wherein the circular liquid header is in a third plane that is below the plane of the circular distribution header;
a gas outlet line that is coupled to the circular gas header and is configured to flow the gases out of the multiphase separation system; and
a liquid outlet line that is coupled to the circular liquid header and is configured to flow the liquids out of the multiphase separation system;
wherein the gas outlet line and the liquid outlet line are coupled via a downcomer configured to allow entrained liquids to flow from the gas outlet line to the liquid outlet line.

2. The multiphase separation system of claim 1, wherein the plurality of upper lines and the plurality of lower lines are perpendicular to the circular distribution header.

3. The multiphase separation system of claim 1, wherein the circular gas header comprises a droplet separation section configured to remove entrained liquids from the gases.

4. The multiphase separation system of claim 1, wherein the circular liquid header comprises a liquid degassing section configured to remove entrained gases from the liquids.

5. The multiphase separation system of claim 1, wherein the multiphase separation system is implemented within a subsea environment.

6. The multiphase separation system of claim 1, wherein the circular distribution header comprises a stratification section configured to separate gases from liquids within the multiphase fluid.

7. The multiphase separation system of claim 1, wherein the multiphase separation system comprises a slug catcher.

8. The multiphase separation system of claim 1, wherein the second plane and the third plane are parallel to the plane of the distribution header.

9. The multiphase separation system of claim 1, wherein the downcomer is configured to allow entrained gases to flow from the liquid outlet line to the gas outlet line.

10. The multiphase separation system of claim 1, wherein the multiphase fluid comprises production fluids from a subsea well.

11. The multiphase separation system of claim 1, wherein a desander is located upstream of the inlet line.

12. The multiphase separation system of claim 1, wherein a desander is located downstream of the liquid outlet line.

13. The multiphase separation system of claim 1, comprising;
an oil/water separation section that is coupled to the circular liquid header and is configured to separate the liquids into oil and water;
an oil outlet line that is coupled to the oil/water separation section and is configured to flow the oil out of the multiphase separation system; and
a water outlet line that is coupled to the oil/water separation section and is configured to flow the water out of the multiphase separation system.

14. The multiphase separation system of claim 13, wherein the oil/water separation section is coupled to the circular distribution header via a sealing downcomer.

15. The multiphase separation system of claim 1, wherein the gas outlet line and the liquid outlet line are not coupled via the downcomer.

16. A method for separation of liquids and gases within a multiphase fluid, comprising:
flowing a multiphase fluid into a circular distribution header of a multiphase separation system;
separating the multiphase fluid into gases and liquids within the circular distribution header;
flowing the gases into a circular gas header that is above a plane of the circular distribution header;
flowing the liquids into a circular liquid header that is below the plane of the circular distribution header;
flowing the gases out of the multiphase separation system via a gas outlet line; and
flowing the liquids out of the multiphase separation system via a liquid outlet line;
wherein entrained liquids within the gas outlet line are flowed to the liquid outlet line via a downcomer.

17. The method of claim 16, comprising flowing the gases into the circular gas header via a plurality of upper lines that are perpendicular the circular distribution header.

18. The method of claim 17, comprising lowering a velocity and a pressure of the gases by splitting the gases among the plurality of upper lines.

19. The method of claim 16, comprising flowing the liquids into the circular liquid header via a plurality of lower lines that are perpendicular the circular distribution header.

20. The method of claim 19, comprising lowering a velocity and a pressure of the liquids by splitting the liquids among the plurality of lower lines.

21. The method of claim 16, comprising flowing entrained gases within the liquid outlet line to the gas outlet line via the downcomer.

22. The method of claim 16, wherein the multiphase separation system is implemented within a subsea environment.

23. The method of claim 16, wherein the multiphase separation system is a slug catcher.

24. The method of claim 16, comprising separating the multiphase fluid into the gases and the liquids within a stratification section of the circular distribution header.

25. The method of claim 16, comprising:
flowing the gases from the multiphase separation system to downstream liquid processing equipment or a gas export line; and
flowing the liquids from the multiphase separation system to downstream gas processing equipment or a liquid export line.

26. The method of claim 16, wherein the liquids comprise residual solid particulates.

27. The method of claim 16, comprising:
separating the liquids into oil and water;
flowing the oil out of the multiphase separation system via an oil outlet line; and
flowing the water out of the multiphase separation system via a water outlet line.
